(19) United States
(12) Patent Application Publication
(10) Pub. No.: US 2026/0317062 A1
(43) Pub. Date: Oct. 15, 2026

(54) SHELF FOR A SHELVING AREA AND METHOD OF MANUFACTURING A SHELF

(71) Applicant: advastore SE, Unterwössen (DE)

(72) Inventor: Leopold MEIRER, Unterwössen (DE)

(73) Assignee: advastore SE, Unterwössen (DE)

(21) Appl. No.: 19/117,291

(22) PCT Filed: Aug. 12, 2024
(86) PCT No.: PCT/EP2024/072717

§ 371 Date: Mar. 31, 2025

(30) Foreign Application Priority Data
Aug. 18, 2023 (DE) 10 2023 122 166.3

(51) Int. Cl. B65G 1/04; A47B 47/02

(52) U.S. Cl. CPC B65G 1/0492; A47B 47/021

(57) ABSTRACT

A shelf (1) for a shelving area (2) of a storage system (3). The shelf includes a storage section (4) which has a first cover layer side (5) and a second cover layer side (6), wherein the storage section is designed to receive goods (7) on the first cover layer side, a rail section (8) which has a contact side (9) and an opposite underside (10), wherein the rail section is designed to support a shuttle at least partially, wherein the first cover layer side and the second cover layer side are provided opposite each other in a first direction (R1), wherein a storage section cavity (11) is formed between the first cover layer side and the second cover layer side, wherein a first reinforcing element (12) is arranged in the storage section cavity, and wherein the first reinforcing element is formed from paper and/or cardboard.

### BACKGROUND OF THE INVENTION

### Field

The present invention relates to a shelf for a shelving area of a storage system, a shelving system and a method for manufacturing a shelf.

### Background

In high-bay warehouses in particular, a large number of storage locations are provided on shelves or racks. Such high-bay warehouses are usually equipped with storage and retrieval machines in order to store and retrieve goods.

For example, DE 20 2004 002 338 U1 shows a system for operating a shelf. Storage and retrieval machines are provided for this purpose, which can operate several shelf levels arranged one above the other.

Due to the increasing demand for storage space and the increasing storage and retrieval frequency, the efficient construction and operation of such shelving systems is of the utmost importance. The shelves in particular, which form the individual storage areas in such a storage system, often have a complicated structure and are very heavy. Furthermore, shelves in storage systems are often complicated to assemble in conjunction with automated storage and retrieval machines, which in turn results in a loss of efficiency

It is therefore an object of the present invention to solve the above problems.

### SUMMARY OF THE INVENTION

The present invention solves these problems with a shelf having the features of claim 1, with a shelving system having the features of claim 9 and with a method for manufacturing a shelf having the features of claim 10. Advantageous embodiments are given in the dependent claims.

According to one aspect of the present invention, a shelf is provided for a shelving area of a storage system. The shelf may comprise a storage section having a first cover layer side and a second cover layer side, wherein the storage section is configured to receive goods on the first cover layer side. The shelf can comprise a rail section which has a contact side and an opposite underside, wherein the rail section is designed to support a shuttle at least partially. The first cover layer side and the second cover layer side can be provided opposite each other in a first direction. A storage section cavity can be formed between the first cover layer side and the second cover layer side. A first reinforcing element can be arranged in the storage section cavity. The reinforcing element can be formed from predominantly cellulose-and/or lignin-containing material, in particular cardboard and/or paper and/or paperboard.

Compared to the prior art, the present invention has the advantage that the shelf is particularly light. Furthermore, a rail section is integrated into the shelf so that a storage and retrieval machine, such as a shuttle, can be guided along the rail section. This means that when the shelf is installed, a travel path for a storage and retrieval machine can be defined automatically without the need to install the travel path and the shelf separately. This eliminates the need to align a rail section relative to the shelf. As a result, the above shelf can achieve a weight saving compared to known shelves with simultaneous integration of a rail section and a storage section. Furthermore, a cost-effective assembly of the shelf together with a rail section can be realized. Preferably, the shelf has a weight of approximately 40 kg.

The shelving area or shelf of a storage system can define a storage area in which a variety of different goods can be stored. For example, the shelving area can be a number of different shelf levels that are arranged one above the other (i.e. in the vertical direction). A shelf can be provided in each shelf level, which defines a storage area for goods in this level. The shelving area can, for example, have vertical supports that support the individual shelves. The shelves can be designed in such a way that goods can be placed on them individually. In other words, the shelf may not have predetermined storage areas, but a continuous storage section (see below). The storage system can be a fully automated storage system that includes the shelving area. Furthermore, the storage system can comprise a rail system on which at least one shuttle (storage and retrieval unit) can travel. In the shelving area, the rail system can be realized by the rail section of the shelves. A separate rail system is therefore only necessary outside the shelving area in the storage system. This can simplify assembly of the storage system as a whole, as the rail systems do not have to be provided separately in the shelving areas. The storage section can be part of the shelf. A first cover layer side can be formed on the storage section, on which the goods to be stored and/or retrieved can be placed. The first cover layer side can be a flat, homogeneous and continuous surface. In other words, the first cover layer side can be free of any kind of boundaries and/or sub-divisions that define specific storage areas. Rather, the goods can be placed individually, i.e. depending on characteristics of the respective goods such as dimensioning and sensitivity, on the first cover layer side of the storage section. For this purpose, a shuttle can be moved along the shelf and store or retrieve a good on the first cover layer side of the storage section at a corresponding point. The second cover layer side can define an underside of the storage section. In other words, the first cover layer side and the second cover layer side may face each other in the first direction. The first direction may extend along the direction of gravity. Accordingly, the first cover layer side may be an upper side of the shelf and the second cover layer side may be a underside of the shelf. The rail section can be designed to provide support for a shuttle. More specifically, the rail section can have a contact side that can come into direct contact with a shuttle. The rail section can be part of a rail system. A shuttle can travel through a rack storage or storage system on a rail system. In particular, the rail section cannot be just any section of a shelf or rack, but is an element specially designed to support a shuttle. Two shelves can be arranged opposite each other in one level of the shelving area. A travel path for the shuttle can be formed between the two shelves. The two shelves can lie opposite each other with their respective rail sections. This means that the shuttle, which has four wheels for example, can travel with two wheels on the rail section of one shelf and with the other two wheels on the rail section of the other shelf. The rail section of one shelf can therefore support the shuttle at least partially. Support can be understood here to mean that the weight of the shuttle is absorbed by the rail section. The rail section can be formed integrally with the storage section. In other words, the shelf can provide both the storage section and the rail section. This eliminates the need to install a separate rail section along a shelf. Furthermore, a weight saving can be achieved by forming a storage section cavity between the first cover layer side and the second cover layer side. This offers significant weight savings compared to a fully solid storage section. As a result, transportation of the shelf can be made more efficient and the weight of the entire shelving area can be reduced. The storage section cavity can have a rectangular cross-section. This allows good rigidity of the storage section to be achieved due to geometric properties. Stiffness is a parameter of technical mechanics. It describes the resistance of a body to an elastic deformation imposed by an external load (force or moment) and conveys the relationship between the load on a component and its deformation. A first reinforcing element can be provided in the storage section cavity to ensure sufficient stability of the storage section. The reinforcing element can be designed to prevent or limit deformation of the shelf (in particular plastic deformation) when a weight is picked up by a good. The reinforcing element can, for example, be an element that is provided on the first cover layer side or the second cover layer side and prevents deformation, in particular bending, of the same. Furthermore, the reinforcing element can be a strut that connects the two faces of the cover layer to prevent the respective face of the cover layer from bending. As a result, the storage section can be sufficiently stable to hold goods on it without deforming plastically and at the same time have a lower weight, which is realized by the storage section cavity. The first reinforcing element can protrude into at least one adjacent cavity. For example, a rail section cavity can be formed in the rail section. The first reinforcing element can also project into the rail section cavity. In other words, only the first reinforcing element can be provided (i.e. as the only reinforcing element). Thus, a one-piece reinforcing element can be provided which is arranged both in the storage section cavity and in the rail section cavity. The reinforcing element can thus be designed as a single piece. This can increase the torsional rigidity of the reinforcing element. Furthermore, the insertion of the reinforcing element into the cavities can be simplified. This means that the shelf can be designed exclusively for use as a shelf or rack. In particular, lightweight boards, especially from the furniture industry or the construction industry, are not suitable for use as shelves or racks. Particularly with regard to deflection, lightweight panels from the furniture industry or the construction industry cannot be used as shelves or racks. Therefore, the term shelf in itself implies a technical suitability to be used as a shelf or in a shelf.

Preferably, the reinforcing element is predominantly made of cellulose and/or lignin-containing material, in particular cardboard and/or paper and/or paperboard. This allows a weight saving to be achieved. Furthermore, the use of predominantly cellulose-and/or lignin-containing material, in particular cardboard and/or paper and/or cardboard, can achieve a suitable reinforcement of the storage section without significantly increasing the overall weight of the compartment bundle. According to DIN 6730, paper can have a mass per unit area of 7 g/m² to 225 g/m². In contrast, cardboard can have a weight per unit area of 225 g/m² or more. Cardboard, paperboard and also paper is a flat material that essentially consists of fibers of vegetable origin or cellulose and is formed by dewatering a fiber suspension on a sieve. The resulting fiber fleece is compacted and dried. This allows a particularly positive CO2 footprint to be achieved for the production of the shelf, especially by using recycled paper. Furthermore, the use of predominantly cellulose and/or lignin-containing material, in particular cardboard and/or paper and/or paperboard, is significantly less energy-intensive compared to creating the reinforcing element from sheet metal or another metal. In addition, the reinforcing element can be produced particularly easily from material containing predominantly cellulose and/or lignin, in particular cardboard and/or paper and/or paperboard.

Preferably, a rail section cavity is formed between the contact side and the underside. In other words, the rail section can also define a cavity. This can further reduce the overall weight of the shelf. In other words, a rail section cavity can be provided between the contact side and the opposite underside. The contact side and the underside can be opposite each other in the first direction. The contact side and the underside can be parallel to each other. This allows sufficient geometric rigidity of the rail section to be achieved, even if a cavity is provided in its interior. Preferably, the rail section cavity has a rectangular cross-section.

Preferably, the rail section cavity has a smaller internal volume than the storage section cavity. The internal volume can be the volume that is at least partially enclosed by the respective section. Since the rail section has a smaller cross-sectional area than the storage section, a smaller rail section cavity is sufficient to provide geometric rigidity of the rail section. Furthermore, the rail section must absorb a lower load than the storage section. Therefore, a smaller rail section cavity can save material for creating the shelf.

Preferably, the contact side and the first cover layer side are spaced apart in the first direction. Furthermore, the first cover layer side and the contact side can be parallel to each other. The first direction may extend along the direction of gravity. The first direction may be orthogonal to the cover layer side and the contact side. In other words, the contact side of the rail section can be arranged lower in the vertical direction than the cover layer side of the storage section. This means that a shuttle traveling on the rail section can be arranged lower in the vertical direction than compared to the first cover layer side. This allows the shuttle to advantageously place the goods it is transporting on the storage section. In other words, the height difference between a transport area of the shuttle for goods and the storage section can be reduced.

Preferably, a second reinforcing element is arranged in the rail section cavity. Preferably, the same reinforcing element (adapted to the possibly smaller rail section cavity) can be arranged in the rail section cavity as in the storage section cavity. As a result, the manufacturing costs can be further reduced by using similar reinforcing elements. Furthermore, by arranging a reinforcing element in the rail section cavity, the rail section can be made more rigid and stable overall, so that even a heavily loaded shuttle can travel over it without any problems and without excessive deformation of the rail section.

Preferably, the first reinforcing element differs from the second reinforcing element. This allows the different loads for the storage section and the rail section to be taken into account. The rail section is more likely to be subjected to dynamic loads and possibly torsional loads, whereas the storage section is subjected to static loads. Furthermore, the storage section is preferably a statically overdetermined system, which is why there are fewer moment loads here compared to the rail section.

The reinforcing elements can differ in terms of their properties. This allows the different requirements of the storage section and the rail section to be taken into account. In the case of the rail section, for example, dynamic loads are generated by a shuttle traveling over it, which must be absorbed in a different way to static loads, which act on the storage section due to the weight of the goods. A further increase in efficiency can be achieved by individually adapting the respective reinforcing elements to their respective area of application. For example, the reinforcing element can differ in terms of its geometric design. For example, the second reinforcing element can have a smaller extension in the first direction than the first reinforcing element (in an installed state). This enables optimum adaptation to the rail section cavity.

Preferably, the reinforcing element has a honeycomb structure. The honeycomb structure can have a large number of individual honeycombs. A honeycomb can be a cell of a pattern of cavities arranged over a surface. For example, honey bees use honeycombs formed from wax in their nests to raise brood and store food. By providing the honeycomb structure in the storage section cavity and/or in the rail section cavity as the first reinforcing element and/or as the second reinforcing element, an increase in strength can be achieved without an excessive increase in weight. The individual honeycombs of the honeycomb structure can be lined up without gaps. The honeycombs can all have the same cross-section. This can make it particularly advantageous to manufacture the honeycomb structure.

Preferably, the honeycomb structure has openings that are continuous in the first direction. In other words, the reinforcing element may be arranged in at least one of the cavities such that at least one opening of the honeycomb structure extends along the first direction. In other words, the reinforcing element can be continuous in the first direction. As a result, the optimum force absorption from one side of the cavity to the other side of the cavity can be realized.

Preferably, the honeycomb structure has a plurality of honeycombs, wherein each honeycomb has a hexagonal cross-section. Of all possible cell shapes that can be arranged in a row without gaps, hexagonal honeycombs have the best ratio of wall material to volume. This shape therefore represents an optimal shape. Consequently, an optimal lightweight construction can be realized with maximum load-bearing capacity. Preferably, the honeycomb structure is arranged in an upright shape in the respective cavity.

Preferably, each honeycomb has a honeycomb width of 14 to 20 millimeters, preferably from 16 mm to 18 mm, more preferably about 18 mm. In the range of 14 mm to 20 mm, it has been found that the optimum rigidity of the shelf can be achieved for use in a shelf. The honeycomb width of 16 mm to 18 mm provides the effect that an optimum ratio of material of the reinforcing element to achievable stiffness of the reinforcing element can be achieved. The value of 18 mm honeycomb width has proven to be particularly advantageous when using the second reinforcing element or the first reinforcing element, which protrudes into the rail section cavity, in the rail section cavity. This honeycomb width has shown that even dynamic loads, which occur when a shuttle passes over the rail section, can be optimally damped. The honeycomb width can be the diameter of a circle that is placed on the cross-section of a honeycomb so that it has the average distance of all points of the honeycomb edge from the center (i.e. a point on the honeycomb axis) of the honeycomb.

Preferably, a ratio of an extension of the shelf in a third direction, which is orthogonal to the first direction, to an extension of the shelf in a second direction, which is orthogonal to the first and third directions, is in a range from 5 to 10, preferably from 6 to 7. The second direction R2 can be the direction in which the storage section adjoins the rail section. The range from 5 to 10 has proven to be advantageous for a shelf that includes a reinforcing element made of paper or cardboard, as the required stability can still be achieved. The range from 6 to 7 is advantageous for high travel speeds of a shuttle, as the vibrations can be minimized here, so that goods on the storage section can be prevented from being displaced unintentionally due to the vibrations.

Preferably, a ratio of an extension of the storage section in a second direction, which is orthogonal to the first direction, to an extension of the rail section in the second direction, is in a range from 10 to 15, preferably from 11 to 12. The range from 10 to 15 offers the advantage that the shuttle has a sufficient support surface on the rail section and at the same time can fully serve the storage section (i.e. can store and retrieve goods). The range from 11 to 12 provides an optimum balance between storage space for goods and space for a shuttle.

Preferably, the first cover layer side is formed on a first cover layer. Preferably, the second cover layer side is formed on a second cover layer. The cover layer can form the storage section. Furthermore, the cover layer can surround the storage section cavity at least in sections. Preferably, the cover layer can be formed from a metal sheet. The storage section cavity can be formed between the cover layers. The distance between the cover layers can be the clear distance between the first cover layer and the second cover layer.

Preferably, the reinforcing element is in contact with the first cover layer and the second cover layer. In other words, the reinforcing element can be provided in the storage section cavity in such a way that the cavity is completely filled by the reinforcing element. The direct contact between the first reinforcing element and the first cover layer and the second cover layer can ensure optimum force transfer or force transmission between the first cover layer and the second cover layer. This can increase the overall stability of the shelf. Furthermore, vibrations that can occur due to small movements of one of the cover layers can be avoided or damped. Analog to this, the second reinforcing element can be in contact with a layer comprising the contact side and an opposite layer comprising the underside. This means that the rail section cavity can also be completely filled by the second reinforcing element in the rail section. In the case of the rail section, this has the additional advantage that the driving noise of a shuttle on the rail section can be reduced.

Preferably, the first cover layer and or the second cover layer has a thickness of 1 mm in the first direction. In other words, the layer can have a material thickness of 1 mm. This allows a shelf to be formed with a relatively thin-walled material that is nevertheless sufficiently stable to hold goods on it. In the same way, the first layer of the rail section, which comprises the contact side, and/or the second layer of the rail section, which comprises the underside, can also be formed with a layer thickness of 1 mm.

Preferably, the first cover layer and the second cover layer are made of galvanized steel. This means that a relatively inexpensive material can be used to create the storage section. In the same way, the first layer and the second layer of the rail section can also be made of galvanized steel.

Preferably, the shelf is integrally formed. In other words, the shelf can be formed in one piece. In particular, the first cover layer side and the second cover layer side of the storage section as well as the first layer and the second layer of the rail section can be formed from one material (i.e. in one piece or integrally). Thus, the rail section and the storage section can be formed integrally in such a way that the two cannot be separated from each other in a non-destructive manner. Thus, a relative positioning between the rail section and the storage section can be realized in such a way that a wrong orientation is not possible. This means that errors during assembly or installation of the storage system can be excluded or at least reduced from the outset. Furthermore, an integral design of the storage section and the rail section can increase the overall strength of the shelf. Preferably, the rail section and the storage section can be formed from the same layer. More specifically, the storage section and the rail section may be formed from the same sheet metal, which is bent to form the storage section and the rail section.

Preferably, the first cover layer and the second cover layer are arranged parallel to each other. This allows the overall shape of the shelf to be simplified. In other words, the storage section can have a rectangular shape at a cross-section. Preferably, the rail section can have a rectangular shape in a cross-section.

Preferably, the contact side and the underside of the rail section are arranged parallel to each other. This means that the rail section can also have a simple design.

Preferably, a transitional cavity is formed between the storage section cavity and the rail section cavity. The transitional cavity may differ from the storage section cavity and/or from the rail section cavity. Since neither a shuttle is moved on the shelf in the area of the transitional cavity, nor goods are deposited there, the requirement for this transitional cavity or the area adjacent to the transitional cavity can be low. It is therefore not necessary for the same reinforcing element to be provided in the transitional cavity as in the storage section cavity and/or the rail section cavity. This means that a simpler reinforcing element or no reinforcing element at all can be provided in the transitional cavity. As a result, the shelf can be designed to be lighter overall and manufacture can be simplified. Furthermore, the transition cavity can be used to compensate for tolerances in the manufacture of the first and/or second reinforcing element. This means that the reinforcing elements can be manufactured more cost-effectively and the shelf can be assembled more easily.

Preferably, the transition cavity is unfilled. In other words, there can be no reinforcing element and/or other device in the transition cavity. On the one hand, this can simplify assembly of the shelf, since in the event that the first reinforcing element and the second reinforcing element are provided in both the storage section cavity and the rail section cavity, both reinforcing elements can be inserted without difficulty. If both hidden elements were in contact with each other, it may be more difficult to insert the reinforcing element into the respective cavities.

Preferably, the reinforcing element is fixed in the storage section cavity and/or the rail section cavity using 1-K PUR surfaces adhesive. This prevents the respective reinforcing elements from slipping. In other words, an optimum position of the reinforcing element in the respective cavity can be ensured.

Preferably, a ratio of the extent of the storage section cavity in the first direction to an extent of the rail section cavity in the first direction is in a range from 3 to 4, preferably about 3.7. In the range from 3 to 4, it has surprisingly been shown that optimum vibration damping is provided when a shuttle passes over the rail section. With the ratio of approximately 3.75, it has been found that even particularly heavy unit loads can be stored on the storage section without causing damage or excessive deformation of the storage section. Furthermore, with this ratio, the heavy goods can also be transported dynamically on the rail section by a shuttle without any problems and without causing excessive noise emissions or vibrations.

Preferably, the shelf has a holding section that protrudes in the first direction from the first cover layer side. The storage section may have a first edge and a second edge. The first edge and the second edge may be spaced apart in a second direction that is orthogonal to the first direction. The rail section may be provided at the first edge of the storage section. The holding section may be provided at the second edge of the storage section. The holding section may protrude vertically upward from the first cover layer side in the first direction (i.e., in the direction of gravity). In other words, the holding section may protrude from an upper surface of the shelf. The holding section can thus serve to prevent goods or piece goods, which are stored on the storage section, from being pushed beyond the storage section and thus falling off the shelf. This can reduce the operational safety and susceptibility to errors of the storage system.

Preferably, the first cover layer side and the second cover layer side are connected by a rear vertical section. The rear vertical section can thus be provided at the second edge of the storage section. The rear vertical section can be oriented at an angle of 90° to the first cover layer side and/or to the second cover layer side. As a result, the storage section can realize an increased geometric rigidity for the storage section so that it can hold even heavy goods.

Preferably, the first cover layer side of the storage section and the contact side of the rail section are connected by a first front vertical section. The first front vertical section may have a shorter extension in the first direction than the rear vertical section. In other words, the first front vertical section may connect the rail section to the first cover layer side of the storage section. Preferably, the first front vertical section is oriented at a 90° angle to the first cover layer side and/or to the contact side of the rail section. This allows a high stability of the shelf to be achieved. Furthermore, the rail section can thus be designed as a step on the shelf. This allows a high degree of rigidity of the shelf to be achieved.

Preferably, the contact side of the rail section and the underside of the rail section are connected by a second front vertical section. The second front vertical section can be parallel to the first front vertical section. The second front vertical section can be aligned at an angle of 90° to the contact side of the rail section and/or to the underside of the rail section. This allows a high degree of rigidity of the shelf to be achieved.

Preferably, the first front vertical section is designed to guide a shuttle at least partially. In other words, a shuttle can rest on the contact side of the rail section and be guided by the first front vertical section. If, for example, the shuttle does not run in a straight line, the first front vertical section can guide the shuttle so that it runs on the contact side of the rail section as desired. In other words, two opposite shelves can be used to create a rail system or a travel path for a shuttle in which the shuttle can be guided by the front vertical sections of the two shelves in a direction orthogonal to the direction of gravity (i.e. in the second direction). This means that the shuttle does not have to be fully maneuverable itself, but can be guided through the shelf (more precisely through the first front vertical section).

Preferably, the second cover layer side and the underside lie in the same plane. In other words, the second cover layer side and the underside can be flush with each other. The second cover layer side of the storage section and the underside of the rail section may be integrally formed and may, for example, be formed from the same sheet metal or the same metal plate. In other words, the rail section can be arranged flush with a surface of the storage section. This allows an L-profile to be formed in a cross-section of the shelf. This offers particular stability advantages due to the geometric shape of a step, as well as simpler manufacturability of the shelf.

According to a further aspect, a shelving area of a storage system is provided comprising a plurality of shelves according to one of the above embodiments.

According to a further aspect of the present invention, a storage system is provided with a shelving area according to the above embodiment and a process area. The process area and the shelving area may be directly adjacent to each other. In other words, the storage system can be a black box system, which can receive containers of goods on an input side and provide individual goods on an output side. The process area can be the area in which at least one container of goods is processed in order to obtain at least one individual good. The shelving area can be the area in which the goods are stored in the shelving area based on goods information. Furthermore, the storage system can have a control unit that can determine or obtain goods information for the at least one good.

According to a further aspect of the present invention, there is provided a method of manufacturing a shelf, in particular according to one of the above embodiments. The method may comprise the following steps: providing a metal sheet, shaping the metal sheet so that a first cover layer side of a storage section and a contact side of a rail section are formed, shaping the metal sheet so that a storage section cavity is formed adjacent to the first cover layer side and the second cover layer side, inserting a reinforcing member into the storage section cavity.

In one embodiment, two metal sheets are used to form the shelf. In other words, a first metal sheet and a second metal sheet can be used. The sheets can both be metal sheets and have identical properties. The first sheet can form an upper part of the shelf. The lower sheet metal may form a lower part of the shelf. The first sheet and the second sheet can contact each other in the area of the rear vertical section or in the area of the holding section as well as in the front vertical section.

Preferably, the two sheets are placed on top of each other during the forming process and an adhesive (e.g. metal adhesive) is applied to the contact points. Preferably, the two sheets overlap in sections. In order to hold the sheets in position, at least one welding point can be provided, which fixes the sheets in position at least temporarily. Preferably, only one spot weld is provided on each contact side of each shelf. This may be sufficient to fix the sheets in position. It should be noted that this method can also be used if only a single sheet is used. The shelf formed in this way can then be heated to activate the adhesive. This allows the contact points of the two sheets or the individual sheet to be bonded so that the shelf is permanently formed. The shelf can be heated in a press. The press can exert pressure on the shelf at the same time or afterwards. This can ensure that the shelf is produced in the desired shape. Furthermore, the pressure exerted by the press can sufficiently bond the contact points using the adhesive. The shelf then cools down. Preferably, the pressure is also exerted on the shelf by the press while it is cooling. This makes it possible to achieve an even more rigid shelf that has a high resistance to twisting.

Preferably, a single integral metal sheet is used to form the shelf. This means that no joining work is required to assemble any multiple components.

Preferably, the metal sheet is bent five times. This allows the L-shaped shelf to be formed, which has an advantageous stability.

Preferably, two free ends of the metal sheet contact each other after forming. Preferably, this contact point is formed at the second front vertical section. In this area, the shelf is the least sensitive and the least forces are dissipated. Therefore, a butt joint in this area is not exposed to high loads and can therefore be permanent.

Preferably, the method further comprises gluing the reinforcing element into the storage section cavity. Similarly, the method may also comprise bonding a reinforcing element into the rail section cavity.

According to a further aspect of the present invention, there is provided a use of a shelf according to one of the above embodiments in a shelving area.

Individual features and embodiments may be combined with other features and other embodiments of the present invention to form new embodiments. Features and advantages mentioned in connection with the individual features or embodiments apply analogously to the new embodiments. The embodiments and advantages mentioned in connection with the device also apply analogously to the method and vice versa.

### BRIEF DESCRIPTION OF THE DRAWINGS

In the following, preferred embodiments are described in detail with reference to the attached figures:

FIG. 1 is a schematic and perspective view of a shelf according to an embodiment of the present invention.

FIG. 2 is a schematic and perspective view of a shelving area according to an embodiment of the present invention.

FIG. 3 is a schematic and perspective view of a part of a storage system according to an embodiment of the present invention.

FIG. 4 is a schematic cross-section of a shelf according to an embodiment of the present invention.

FIG. 5 is a perspective and schematic view of a reinforcing element according to an embodiment of the present invention.

FIG. 6 is a schematic and perspective view of a shelf according to an embodiment of the present invention.

### DETAILED DESCRIPTION OF THE INVENTION

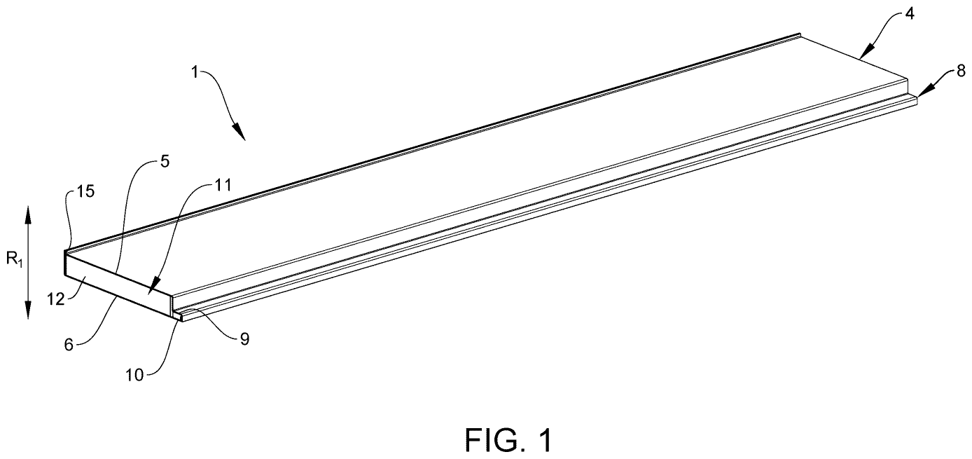

FIG. 1 is a schematic perspective view of a shelf 1 according to an embodiment of the present invention. The shelf 1 has a storage section 4 and a rail section 8. Goods can be placed individually on the storage section 4. The rail section 8 is designed to guide and support a shuttle as an example of a storage and retrieval unit. The rail section 8 is integrally provided on the storage section 4. The storage section 4 has a first cover layer side 5 on its upper side in the vertical direction (i.e. in the direction R1). A second cover layer side 6 opposite the first cover layer side 5 is oriented downwards in the first direction R1. Analogue to this, the rail section 8 has a contact side 9 oriented upwards in the first direction R1 and an opposite underside 10. The designations top and bottom refer to an operating state, i.e. to an installed state, of the shelf 1. A storage section cavity 11 is provided between the first cover layer side 5 and the second cover layer side 6. In other words, the storage section, which is formed as a profile element with the cover layer side 5 and the second cover layer side 6 as a boundary, can have an interior space. A first reinforcing element 12 can be arranged in this interior space. In the present embodiment, the reinforcing element 12 is formed from predominantly cellulose- and/or lignin-containing material, in particular cardboard and/or paper and/or paperboard. The reinforcing element 12 contacts both the first cover layer side 5 and the second cover layer side 6, which makes it possible to realize a stable storage section 4. Furthermore, in the present embodiment, a rail section cavity 13 is formed between the contact side 9 of the underside 10 of the rail section 8. A second reinforcing element 14 is arranged in the rail section cavity 13. In another embodiment, not shown, the first reinforcing element 12 is arranged both in the rail section cavity 13 and in the storage section cavity 11. The second reinforcing element 14 is formed from paper and/or cardboard. The second reinforcing element 14 contacts both the contact side 9 and the underside 10. The shelf 1 can have an extension in a second direction R2 (i.e. orthogonal to the first direction R1) of 545 mm. The rail section may have an extension of 45 mm in the second direction. Furthermore, the rail section may extend in a third direction R3, which is orthogonal to the first direction R1 and to the second direction R2. The shelf can have an extension in the third direction R3 of 3391 mm. The rail section 8 can have an extension in the first direction R1 of 20 mm. The shelf 1 can have an extension of 40 mm in the first direction R1. With the above dimensions, the shelf has a weight of approximately 40 kg.

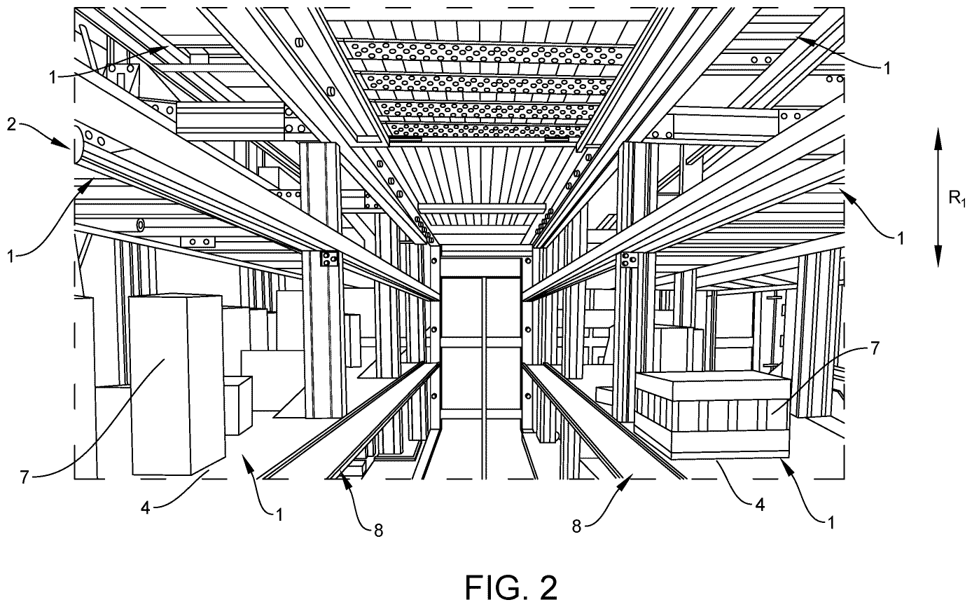

FIG. 2 is a schematic and perspective view of a shelving area 2 with a plurality of shelves 1 in an assembled state. It can also be seen in FIG. 2 that goods are arranged individually on the storage section 4 of the shelves 1. The goods 7 are arranged freely on the storage sections of the shelves 1 without the storage sections 4 having to be subdivided in any way or have any defined storage areas. It can also be seen that two shelves 1 are arranged opposite each other on one shelf level. The shelves 1 face each other with their respective rail sections 8. This means that the rail sections 8 of the two shelves 1, which are opposite each other on one shelf level, form a rail system on which a shuttle with four wheels can travel (see central area of FIG. 2). The shuttle can move in the third direction R3. FIG. 2 also shows that several shelf levels are arranged one above the other (i.e. in the first direction R1) in the shelving area.

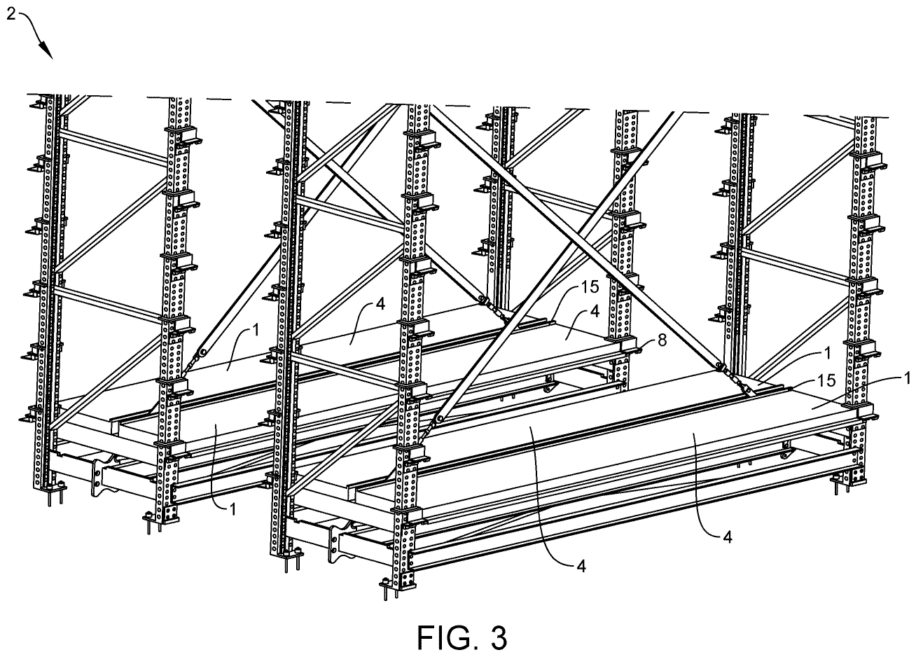

FIG. 3 is a schematic and perspective view of a shelving area 2 according to a further embodiment of the present invention. In the shelving area shown in FIG. 3, only one shelf level is fitted with shelves 1. It can be seen here that shelves are always arranged either with their rail sections 8 facing each other, or with their storage sections 4. A greater distance is formed between the shelves 1, which face each other with their rail sections 8, compared with the shelves 1, which face each other with the storage section. It can also be seen in FIG. 3 that vertical (i.e. running in the first direction) support pillars are provided, to which the shelves 1 are fixed. Since the shelves already comprise a storage section 4 for goods and a rail section 8 for the supply of a shuttle, only the shelves 1 need to be attached to the vertical posts to form the shelving area. Depending on the design, load capacity and height of the shelving area, further cross bracing can then be provided using beams or clamping elements.

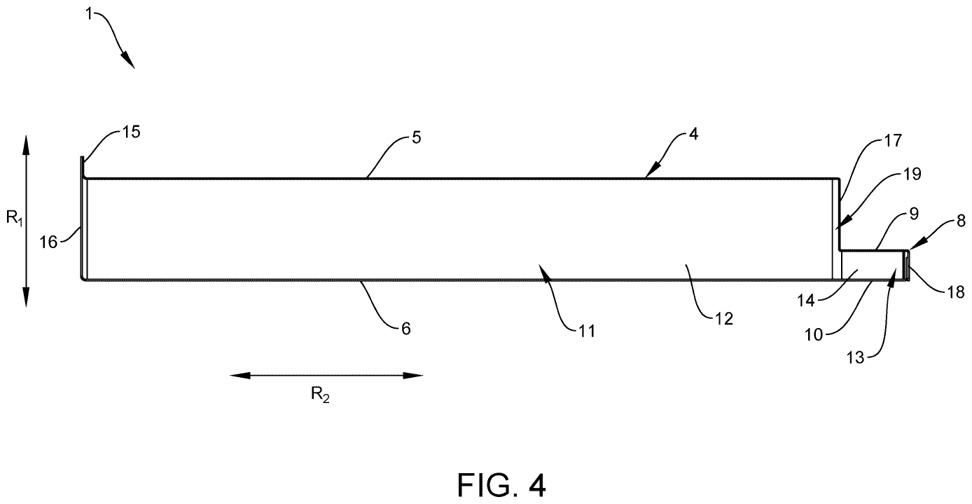

FIG. 4 is a schematic cross-section through a shelf 1 according to an embodiment of the present invention. In other words, FIG. 4 shows a cross-section through a profile forming the shelf 1. As in the previous embodiments, the storage section 4 has a first cover layer side 5 and an opposite second cover layer side 6. In the same way, the rail section 8 of the present embodiment also has a contact side 9 and an opposite underside 10. The shelf 1 formed in this way has an L-shaped cross-section. The underside 10 and the second cover layer side 6 run continuously and in one and the same plane. The first reinforcing element 12 is arranged in the storage section cavity 11. The second reinforcing element is arranged in the rail section cavity 13. A transition cavity 19 is formed between the storage section cavity 11 and the rail section cavity 13. In the present embodiment, the transition cavity 19 is empty, so that the first reinforcing element 12 and the second reinforcing element 14 are spaced apart (i.e. are not in direct contact with each other). This can prevent vibrations that are introduced into the second reinforcing element 14, for example when a shuttle passes over the rail section 8, from being passed on to the first reinforcing element 12. Furthermore, in the present embodiment, the shelf has a rear vertical section 16, which connects the first cover layer side 5 to the second cover layer side 6. The rear vertical section 16 extends in the first direction R1. Furthermore, the shelf 1 of the present embodiment has a first front vertical section which connects the contact side 9 of the rail section 8 to the first cover layer side 5. The first front vertical section 17 extends in the first direction R1. The contact side 9 is connected to the underside 10 of the rail section 8 via a second front vertical section 18. The second front vertical section 18 extends in the first direction R1. Furthermore, in the present embodiment, the shelf is formed from only one metal sheet, which is bent until the profile body is formed, which forms the storage section 4 and the rail section 8 (i.e. the shelf 1). In the present embodiment, the ends of the metal sheet meet at the second front vertical section 18. In this area, the ends of the metal sheet overlap. This prevents the profile from opening and creates a sufficiently large area for connecting the ends of the metal sheet. Furthermore, the second front vertical section 18 is subject to the lowest load on the shelf, so that breaking of the connection can be avoided in this area. Furthermore, in the present embodiment, the shelf has a holding section 15 which projects away from the first cover layer side 5 in the first direction R1. In the present embodiment, holding section 15 is formed continuously with the rear vertical section 16. The holding section 15 prevents goods 7 from being pushed beyond the storage section 4. This prevents goods from falling off the shelf 1.

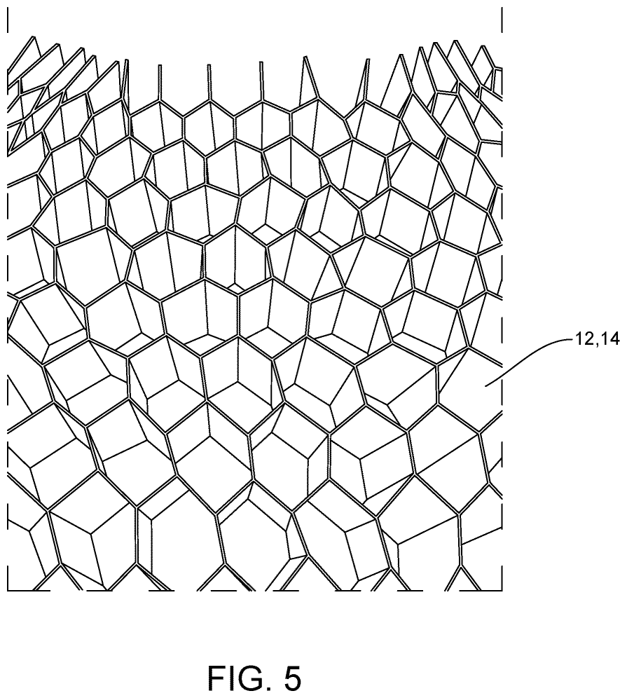

FIG. 5 is a schematic view of a honeycomb structure as encompassed by the second reinforcing element 14 in the first reinforcing element 12. The honeycomb structure has a plurality of individual honeycombs, each of which has a hexagonal shape and is directly adjacent to one another.

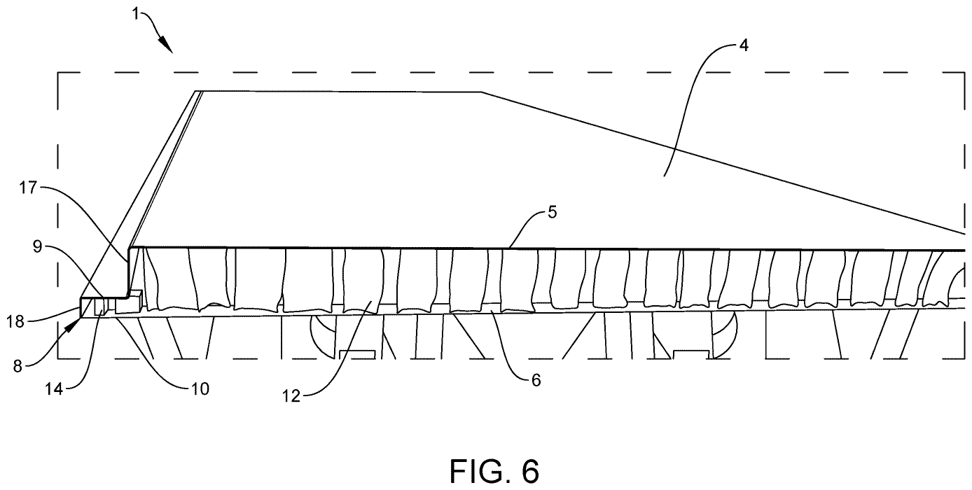

FIG. 6 is a schematic and perspective view of a shelf with an open profile. The first reinforcing element 12 and second reinforcing element 14 are therefore visible. Furthermore, in the present embodiment, it can be seen that the metal sheet is fastened together butt-jointed at the second front vertical section 18, so that the profile forming the shelf 1 is formed.

### List of Reference Signs

1 Shelf
2 Shelving area
3 Storage system
4 Storage section
5 First cover layer side
6 Second cover layer side
7 Goods
8 Rail section
9 Contact side
10 Underside
11 Storage section cavity
12 First reinforcing element
13 Rail section cavity
14 Second reinforcing element
15 Holding section
16 Rear vertical section
17 First front vertical section
18 Second front vertical section
19 Transition cavity
R1 First direction
R2 Second direction
R3 Third direction

1. Shelf (1) for a shelving area (2) of a storage system (3), comprising
a storage section (4) which has a first cover layer side (5) and a second cover layer side (6), wherein the storage section (4) is designed to receive goods (7) on the first cover layer side (5),
a rail section (8) which has a contact side (9) and an opposite underside (10), wherein the rail section (8) is designed to support a shuttle at least partially,
wherein the first cover layer side (5) and the second cover layer side (6) are provided opposite each other in a first direction (R1),
wherein a storage section cavity (11) is formed between the first cover layer side (5) and the second cover layer side (6),
wherein a first reinforcing element (12) is arranged in the storage section cavity (11), and
wherein the first reinforcing element (12) is formed predominantly from cellulose-and/or lignin-containing material, in particular cardboard and/or paper and/or paperboard.

2. Shelf (1) according to claim 1, wherein a rail section cavity (13) is formed between the contact side (9) and the underside (10), wherein a second reinforcing element (14) is preferably arranged in the rail section cavity (13).

3. Shelf (1) according to claim 2, wherein the rail section cavity (13) has a smaller internal volume than the storage section cavity (11).

4. Shelf (1) according to claim 2, wherein the first reinforcing element (12) is different from the second reinforcing element (14).

5. Shelf (1) according to claim 2, wherein the reinforcing elements (12, 14) differ in terms of their properties.

6. Shelf (1) according to claim 2, wherein a transition cavity (19) is formed between the storage section cavity (11) and the rail section cavity (13).

7. Shelf (1) according to claim 6, wherein the transitional cavity (19) is unfilled.

8. Shelf (1) according to claim 2, wherein a ratio of an extension of the storage section cavity (11) in the first direction (R1) to an extension of the rail section cavity (13) in the first direction (R1) is in a range of 3 to 4, preferably about 3.7.

9. Shelf (1) according to claim 1, wherein the contact side (9) and the first cover layer side (5) are spaced apart from each other in the first direction (R1).

10. Shelf (1) according to claim 1, wherein the reinforcing element (12, 14) has a honeycomb structure.

11. Shelf (1) according to claim 10, wherein the honeycomb structure has openings which are continuous in the first direction.

12. Shelf (1) according to claim 10, wherein the honeycomb structure comprises a plurality of honeycombs, wherein each honeycomb has a hexagonal cross-section.

13. Shelf (1) according to claim 10, wherein each honeycomb has a honeycomb width of 14 to 20 millimeters, preferably of 16 mm to 18 mm, more preferably of about 18 mm.

14. Shelf (1) according to claim 1, wherein a ratio of an extension of the shelf (1) in a third direction, which is orthogonal to the first direction, to an extension of the shelf (1) in a second direction, which is orthogonal to the first and third directions, is in a range from 5 to 10, preferably from 6 to 7.

15. Shelf (1) according to claim 1, wherein a ratio of an extension of the storage section (4) in a second direction, which is orthogonal to the first direction, to an extension of the rail section (8) in the second direction, is in a range from 10 to 15, preferably from 11 to 12.

16. Shelf (1) according to claim 1, wherein the first cover layer side (5) is formed on a first cover layer.

17. Shelf (1) according to claim 1, wherein the second cover layer side (6) is formed on a second cover layer.

18. Shelf (1) according to claim 16, wherein the reinforcing element (12, 14) is in contact with the first cover layer and the second cover layer.

19. Shelf (1) according to claim 16, wherein the first cover layer and or the second cover layer has a thickness of 1 mm in the first direction.

20. Shelf (1) according to claim 16, wherein the first cover layer and the second cover layer are formed of galvanized steel.

21. Shelf (1) according to claim 1, wherein the reinforcing element (12, 14) is fixed in the storage section cavity (11) and/or the rail section cavity (13) by means of 1-K PUR surfaces adhesive.

22. Shelf (1) according to claim 1, wherein the shelf (1) is integrally formed.

23. Shelf (1) according to claim 1, wherein the first cover layer and the second cover layer are arranged parallel to each other.

24. Shelf (1) according to claim 1, wherein the contact side (9) and the underside (10) of the rail section (8) are arranged parallel to each other.

25. Shelf (1) according to claim 2, wherein a ratio of an extension of the storage section cavity (11) in the first direction to an extension of the rail section cavity (13) in the first direction is in a range of 3 to 4, preferably about 3.

26. Shelf (1) according to claim 1, wherein the shelf (1) comprises a holding section (15) projecting in the first direction (R1) from the first cover layer side (5).

27. Shelf (1) according to claim 1, wherein the first cover layer side (5) and the second cover layer side (6) are connected by a rear vertical section (16).

28. Shelf (1) according to claim 1, wherein the first cover layer side (5) of the storage section (4) and the contact side (9) of the rail section (8) are connected by a first front vertical section.

29. Shelf (1) according to claim 28, wherein the first front vertical section (17) is designed to guide a shuttle at least partially.

30. Shelf (1) according to claim 1, wherein the contact side (9) of the rail section (8) and the underside (10) of the rail section (8) are connected by a second front vertical section (18).

31. Shelf (1) according to claim 1, wherein the second cover layer side (6) and the underside (10) lie in the same plane.

32. Shelving area (2) of a storage system (3) comprising a plurality of shelves (1) according to claim 1.

33. Method of manufacturing a shelf (1), in particular according to claim 1, comprising:
Providing a metal sheet,
Forming the metal sheet so that a first cover layer side (5) of a storage section (4) and a contact side (9) of a rail section (8) are formed,
Forming of the metal sheet so that a storage section cavity (11) is formed adjacent to the first cover layer side (5),
Inserting of a reinforcing element (12, 14) into the storage section cavity (11).

34. Method according to claim 33, wherein a single integral metal sheet is used to form the shelf (1).

35. Method according to claim 33, wherein two free ends of the metal sheet contact each other after forming.

36. Method according to claim 33, wherein the metal sheet is bent five times.
